(19) United States
(12) Patent Application Publication
(10) Pub. No.: US 2003/0184857 A1
(43) Pub. Date: Oct. 2, 2003

(54) Microscope having apparatus for determining the light power level of an illuminating light beam

(75) Inventor: William C. Hay, Heppenheim (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Leica Microsystems Heidelberg GmbH, Mannheim (DE)

(21) Appl. No.: 10/400,604

(22) Filed: Mar. 27, 2003

(30) Foreign Application Priority Data
Mar. 30, 2002 (DE) DE 202 05 081.5

(51) Int. Cl. G02B 21/00; G02B 21/06; G02B 23/00; G02B 5/30; G02B 27/28; G02B 5/28; G02B 27/14

(52) U.S. Cl. 359/385; 359/368; 359/380; 359/431; 359/498; 359/589; 359/634

(57) ABSTRACT

A microscope has a light source that emits an illuminating light beam for illumination of a specimen, an apparatus for determining the light power level of the illuminating light beam and a beam splitter separating measuring light out of the illuminating light beam. The microscope permits determination of the light power level of the illuminating light beam with an apparatus for simultaneous color-selective detection of the measuring light.

### CROSS REFERENCE TO RELATED APPLICATIONS

This application claims priority to German utility model application 202 05 081.5, which is hereby incorporated by reference herein.

### BACKGROUND

The invention concerns a microscope.

The invention further concerns an apparatus for determining the light power level of an illuminating light beam.

It is general practice, in order to measure the power level of a light beam, to divide a measuring beam out of the light beam using a beam splitter and, by means of a detector that generates an electrical signal proportional to the power level of the measuring beam, firstly to determine the power level of the measuring beam and then, with a knowledge of the splitting ratio of the beam splitter, to draw conclusions as to the power level of the light beam.

In scanning microscopy, a specimen is illuminated with a light beam in order to observe the detected light emitted, as reflected or fluorescent light, from the specimen. The illuminating light beam can contain light of several wavelengths, for example in order to excite several dyes simultaneously. The focus of an illuminating light beam is moved in a specimen plane by means of a controllable beam deflection device, generally by tilting two mirrors; the deflection axes are usually perpendicular to one another, so that one mirror deflects in the X direction and the other in the Y direction. Tilting of the mirrors is brought about, for example, by means of galvanometer positioning elements. The power level of the detected light coming from the specimen is measured as a function of the position of the scanning beam. The positioning elements are usually equipped with sensors to ascertain the present mirror position.

In confocal scanning microscopy specifically, a specimen is scanned in three dimensions with the focus of a light beam. A confocal scanning microscope generally comprises a light source, a focusing optical system with which the light of the source is focused onto a diaphragm (called the “excitation pinhole”), a beam splitter, a beam deflection device for beam control, a microscope optical system, a detection pinhole, and the detectors for detecting the detected or fluorescent light. The illuminating light is coupled in via a beam splitter. The fluorescent or reflected light coming from the specimen travels back through the beam deflection device to the beam splitter, passes through it, and is then focused onto the detection pinhole behind which the detectors are located. This detection arrangement is called a “descan” arrangement. Detected light that does not derive directly from the focus region takes a different light path and does not pass through the detection pinhole, so that a point datum is obtained which results, by sequential scanning of the specimen, in a three-dimensional image. A three-dimensional image is usually achieved by acquiring image data in layers. Commercial scanning microscopes usually comprise a scanning module that is flange-mounted onto the stand of a conventional light microscope, the scanning module containing all the aforesaid elements additionally necessary for scanning a specimen.

One known method of compensating for or correcting fluctuations in the illuminating light power level is based on dividing a measuring beam out of the illuminating light beam with a beam splitter, and using the ratio of the measured power levels of the measuring beam and detected light beam for image generation or image calculation. This procedure is disclosed, for example, in the publication by G. J. Brakenhoff, Journal of Microscopy, Vol. 117, pt. Nov. 2, 1979, pp. 233-242.

German Unexamined Application DE 197 02 753 A1 discloses an arrangement for monitoring the laser radiation coupled into a scanning head, by means of a detection element onto which a portion of the incoupled radiation is directed via a beam splitter. This arrangement can be equipped with exchangeable filters in order to make possible wavelength-dependent monitoring of the laser radiation. The arrangement has the disadvantage that without a filter wheel, only the overall power level of the illuminating light beam, which in many applications is made up of light of several wavelengths, can be monitored. For example, if the light of two different lasers is combined into one illuminating light beam, any fluctuation that occurs in the power level of a laser can be recorded, but it cannot be corrected or compensated for because allocation is not possible. The use of the filters solves this problem, but with a great deal of outlay, especially in terms of time, on the part of the microscope user. In addition, exchanging of the filters by the user entails the risk of unintentional misalignments and other external disruptions, in particular vibrations and thermal influences, which limit the reproducibility and accuracy of the measurement.

### SUMMARY OF THE INVENTION

It is therefore an object of the invention to provide a microscope that makes possible efficient, reliable, and accurate determination and monitoring of the light power level of the illuminating light beam even in multi-color applications.

The invention provides a microscope comprising:

a light source that emits an illuminating light beam for illumination of a specimen,

a beam splitter separating measuring light out of the illuminating light beam, and

an apparatus for determining the light power level of the illuminating light beam,

which receives the measuring light and which comprises an apparatus for simultaneous color-selective detection of the measuring light.

A further object of the invention is to provide an apparatus that allows efficiently and reliably to determine the light power level of a multi-color illuminating light beam.

The present invention also provides an apparatus for determining the light power level of an illuminating light beam comprising: a beam splitter that separates measuring light out of the illuminating light beam, and an apparatus for simultaneous color-selective detection of the measuring light.

The invention has the advantage it makes possible reliable and rapid (online) measurement and monitoring of the power level of all spectral components of the illuminating light beam, and thus at the same time creates the prerequisites for compensating, even in the context of multi-color applications, for fluctuations in the illuminating light power level of the illuminating light beam or fluctuations in components of the illuminating light beam, for example in a closed-loop control system.

In a preferred embodiment, the apparatus for simultaneous color-selective detection comprises a spatially spectrally dividing element that preferably is embodied as a prism. It can also be embodied, for example, as a grating, in particular as a transmission grating. In a very particularly preferred embodiment, one surface (preferably coated) of the prism constitutes the beam splitter. The coating can be, for example, a partial mirror coating.

A further disadvantage exhibited by the arrangement known from the existing art, namely that interference effects brought about by multiple reflections occur at a plane-parallel beam splitter substrate because of its thinness, and result in severe intensity fluctuations at the detector, is also eliminated in the apparatus according to the present invention. Since there are no parallel surfaces in a prism, multiple reflections cannot in this case result in interference phenomena at the detector.

In order to avoid reflections that, after multiple deflection within the prism, ultimately strike the detector and distort the signal there, individual surfaces of the prism can be roughened.

In a preferred embodiment, the apparatus for simultaneous color-selective detection comprises at least one detector that receives the measured light. In a very particularly preferred embodiment, the detector is made up of several individual detectors that each receive spectrally different components of the measured light. The detector can contain, for example, a photodiode or a photomultiplier or a photodiode row or a photodiode array or a CCD element or a photomultiplier array or a photomultiplier row. The individual detectors are preferably each individually calibrated for the wavelength that they receive.

In another preferred embodiment, the detector is arranged directly on the apparatus for simultaneous color-selective detection. Preferably the entry window of the detector is cemented directly onto the exit surface of the prism. This prevents disruptive interference effects due to multiple reflections between the prism and detector.

### BRIEF DESCRIPTION OF THE DRAWINGS

The subject matter of the invention is depicted in the drawings and will be described below with reference to the Figures, identically functioning elements being labeled with the same reference characters. In the drawings:

FIG. 1 shows an apparatus according to the present invention for determining the light output of an illuminating light beam;

FIG. 2 shows a further apparatus according to the present invention for determining the light output of an illuminating light beam;

FIG. 3 shows a further apparatus according to the present invention for determining the light output of an illuminating light beam;

FIG. 4 shows a further apparatus according to the present invention for determining the light output of an illuminating light beam; and

FIG. 5 shows a microscope according to the present invention.

### DETAILED DESCRIPTION

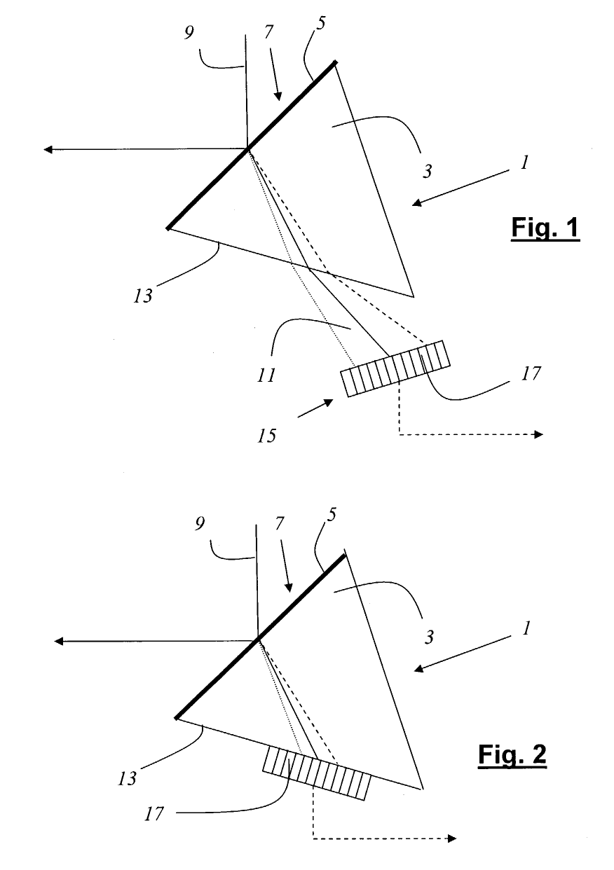

FIG. 1 shows an apparatus according to the present invention for determining the light power level of an illuminating light beam. The apparatus comprises a spatially spectrally dividing element 1 that is embodied as prism 3. A first surface of the prism is provided with a partially reflective coating 5, and constitutes a beam splitter 7. Illuminating light beam 9 strikes beam splitter 7. At coating 5, 5% of the illuminating light beam is divided out as measured light 11, which is spatially spectrally spread out by prism 3 and leaves prism 3 through an exit surface 13. The measured light then strikes a detector 15 that is embodied as photodiode row 17. In the individual detectors of the photodiode row, electrical signals proportional in current intensity to the light power level of the respective spectral component are generated.

FIG. 2 shows a further apparatus according to the present invention for determining the light power level of an illuminating light beam. In this embodiment the detector is cemented directly onto the exit surface of the prism.

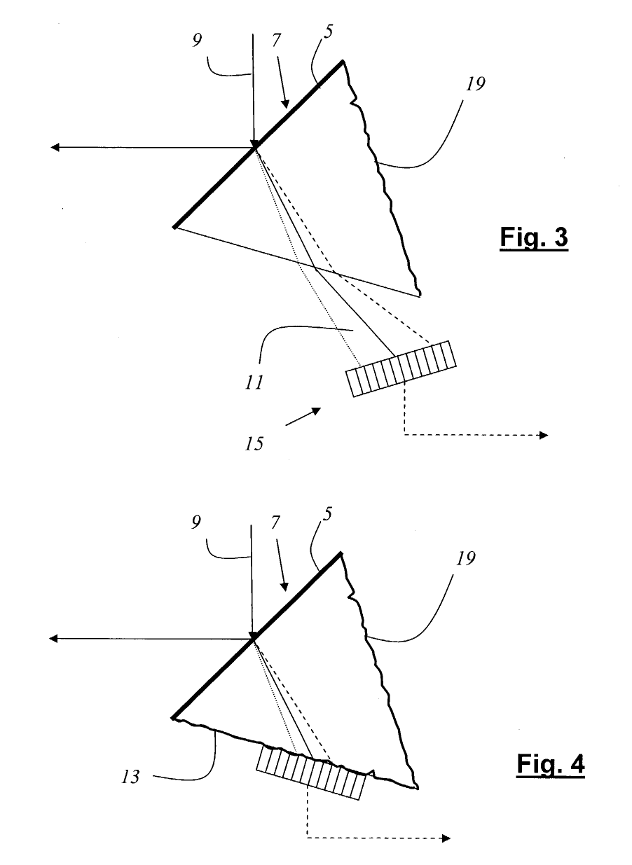

FIG. 3 shows a further apparatus according to the present invention for determining the light power level of an illuminating light beam. In this embodiment, a third surface 19 of prism 3 is roughened in order to suppress unwanted reflections.

FIG. 4 shows a further apparatus according to the present invention for determining the power level of an illuminating light beam, which corresponds largely to the embodiment shown in FIG. 2. In this embodiment, a third surface 19 of prism 3, and exit surface 13, are roughened in order to suppress undesired reflections.

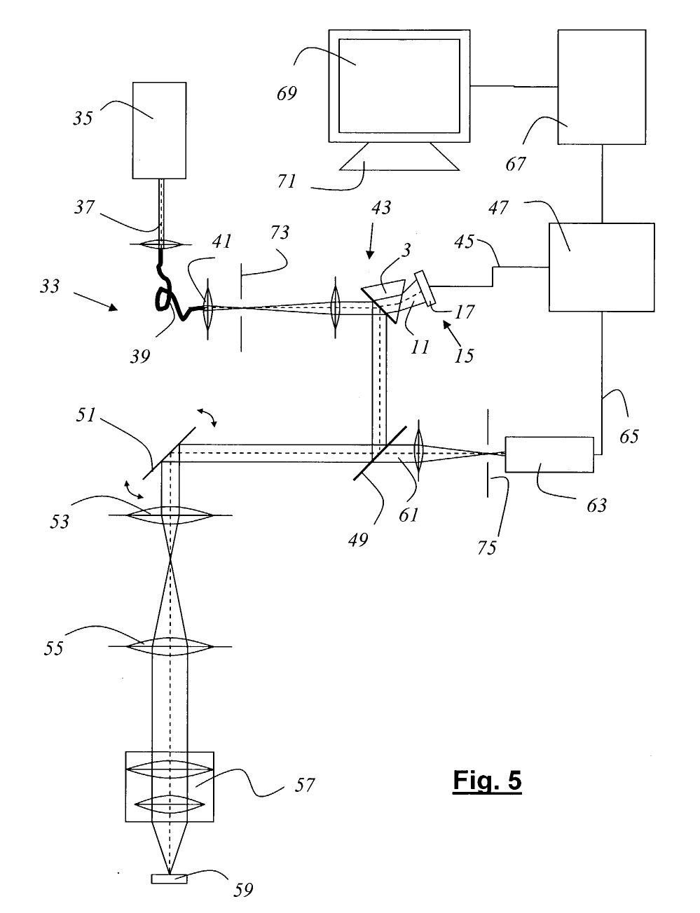

FIG. 5 schematically shows a microscope 33 according to the present invention, which is embodied as a confocal scanning microscope. Light beam 37 coming from an illumination system 35 is transported via a glass fiber 39 and, after being coupled out of glass fiber 39 by means of optical system 41, strikes an apparatus 43 for determining the power level of illuminating light beam 37, which corresponds largely to the apparatus shown in FIG. 1 having a prism 3 and a photodiode row 17. Detector 15 generates electrical signals proportional to the power level of the respective spectral components of measured light 11, which are forwarded via conductor 45 to processing unit 47. By way of a beam splitter 49, illuminating light beam 37 arrives at gimbal-mounted scanning mirror 51 that guides the beam, through scanning optical system 53, tube optical system 55, and objective 57, over or through specimen 59. In the case of non-transparent specimens 59, illuminating light beam 37 is guided over the specimen surface. With biological specimens 59 (preparations) or transparent specimens, illuminating light beam 37 can also be guided through specimen 59. This means that different focal planes of the specimen are successively scanned by illuminating light beam 37. Subsequent assembly then yields a three-dimensional image of the specimen. Detected light 61 proceeding from specimen 59 travels through objective 57, tube optical system 55, and scanning optical system 53, and via scanning mirror 51 to beam splitter 49, passes through the latter and strikes a detector apparatus 63, which is embodied as a multi-band detector. In detector apparatus 63, which is embodied as a multi-band detector, electrical detected signals proportional to the power level of the detected light are generated in spectrally selective fashion and are forwarded via conductor 65 to processing unit 47. In processing unit 47, the incoming analog signals are first digitized and then digitally correlated with one another, and corrected detected light power levels are determined. These are forwarded to a PC 67. The corrected detected light power levels are allocated, on the basis of a position signal of the gimbal-mounted mirror, to the position of the associated grid point, and the data of all the grid points are assembled into an image of specimen 69 that is displayed on a display 71. Illumination pinhole 73 and detection pinhole 75 that are usually provided in a confocal scanning microscope are schematically drawn in for the sake of completeness. Omitted in the interest of better clarity, however, are certain optical elements for guiding and shaping the light beams. These are sufficiently familiar to a person skilled in this art.

The invention has been described with reference to a particular exemplary embodiment. It is self-evident, however, that changes and modifications can be made without thereby leaving the range of protection of the claims below.

What is claimed is:

1. A microscope comprising:
a light source that emits an illuminating light beam for illumination of a specimen, a beam splitter separating measuring light out of the illuminating light beam, and an apparatus for determining the light power level of the illuminating light beam, which receives the measuring light and which comprises an apparatus for simultaneous color-selective detection of the measuring light.

2. The microscope as defined in claim 1, wherein the apparatus for simultaneous color-selective detection comprises a spatially spectrally dividing element.

3. The microscope as defined in claim 2, wherein the spatially spectrally dividing element is a prism.

4. The microscope as defined in claim 3, wherein one surface of the prism constitutes the beam splitter.

5. The microscope as defined in claim 4, wherein the surface of the prism is coated in partially reflective fashion.

6. The microscope as defined in claim 4, wherein at least one surface of the prism is roughened.

7. The microscope as defined in claim 1, wherein the apparatus for simultaneous color-selective detection comprises at least one detector that receives the measuring light.

8. The microscope as defined in claim 7, wherein the detector consists of several individual detectors that each receive spectrally different components of the measuring light.

9. The microscope as defined in claim 7, wherein the detector contains a photodiode or a photomultiplier or a photodiode row or a photodiode array or a CCD element or a photomultiplier array or a photomultiplier row.

10. The microscope as defined in claim 7, wherein the detector is arranged directly on the apparatus for simultaneous color-selective detection.

11. An apparatus for determining the light power level of an illuminating light beam comprising:
a beam splitter that separates measuring light out of the illuminating light beam, and an apparatus for simultaneous color-selective detection of the measuring light.

12. The apparatus as defined in claim 11, wherein the apparatus for simultaneous color-selective detection comprises a spatially spectrally dividing element.

13. The apparatus as defined in claim 12, wherein the spatially spectrally dividing element is a prism.

14. The apparatus as defined in claim 13, wherein one surface of the prism constitutes the beam splitter.

15. The apparatus as defined in claim 14, wherein the surface of the prism is coated in partially reflective fashion.

16. The apparatus as defined in claim 14, wherein at least one surface of the prism is roughened.

17. The apparatus as defined in claim 11, wherein the apparatus for simultaneous color-selective detection comprises at least one detector that receives the measuring light.

18. The apparatus as defined in claim 17, wherein the detector comprises several individual detectors that each receive spectrally different components of the measuring light.

19. The apparatus as defined in claim 17, wherein the detector contains a photodiode or a photomultiplier or a photodiode row or a photodiode array or a CCD element or a photomultiplier array or a photomultiplier row.

20. The apparatus as defined in claim 17, wherein the detector is arranged directly on the apparatus for simultaneous color-selective detection.
